(19) United States
(12) Patent Application Publication
(10) Pub. No.: US 2013/0246352 A1
(43) Pub. Date: Sep. 19, 2013

(54) SYSTEM, METHOD, AND COMPUTER PROGRAM PRODUCT FOR GENERATING A FILE SIGNATURE BASED ON FILE CHARACTERISTICS

(71) Applicants: Joel R. Spurlock, Newberg, OR (US); Anthony V. Bartram, Milton Keynes (FI)

(72) Inventors: Joel R. Spurlock, Newberg, OR (US); Anthony V. Bartram, Milton Keynes (FI)

(21) Appl. No.: 12/486,575

(22) Filed: Jun. 17, 2009

(51) Int. Cl. G06F 12/00; G06F 17/30

(52) U.S. Cl. 707/615; 707/E17.01; 707/E17.005

(57) ABSTRACT

A system, method, and computer program product are provided for generating a file signature using file characteristics. In use, a plurality of characteristics of a file is identified. Furthermore, a signature for the file is generated based on a combination of the characteristics.

### FIELD OF THE INVENTION

The present invention relates to signatures, and more particularly to generating signatures of files.

### BACKGROUND

Recently, automatic generation of file signatures has been used for eliminating manual processing in generating the file signatures (e.g. to save time, etc. in generating the file signatures). Typically, files have been hashed by hashing the contents thereof for generating the file signatures in this automated manner. Unfortunately, employing techniques to automatically generate file signatures using file hashing has resulted in various limitations.

For example, conventional hashing mechanisms oftentimes result in file hashes of significant size, such that efficient storage of the file hashes is not provided. As another example, a hash has generally only identified the specific file which was hashed, such that variations of the file (whether or not previously known) cannot be identified by the hash of the file. There is thus a need for addressing these and/or other issues associated with the prior art.

### SUMMARY

A system, method, and computer program product are provided for generating a file signature using file characteristics. In use, a plurality of characteristics of a file is identified. Furthermore, a signature for the file is generated based on a combination of the characteristics.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 shows a method for generating a file signature using file characteristics, in accordance with one embodiment.

FIG. 4 shows a method for generating a hash of a file based on a combination of characteristics of the file, in accordance with another embodiment.

FIG. 5 shows a file signature which describes a plurality of file characteristics, in accordance with yet another embodiment.

### DETAILED DESCRIPTION

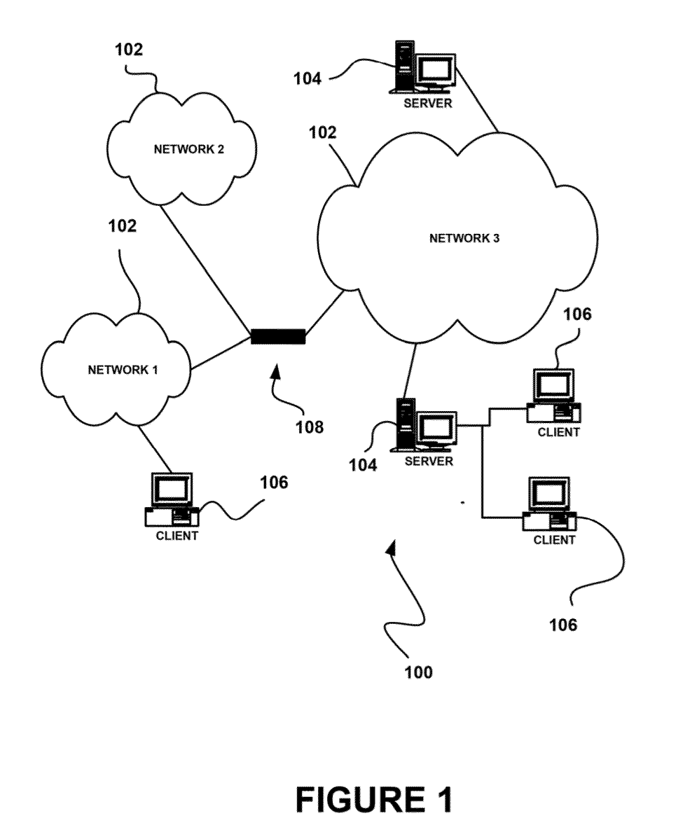

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

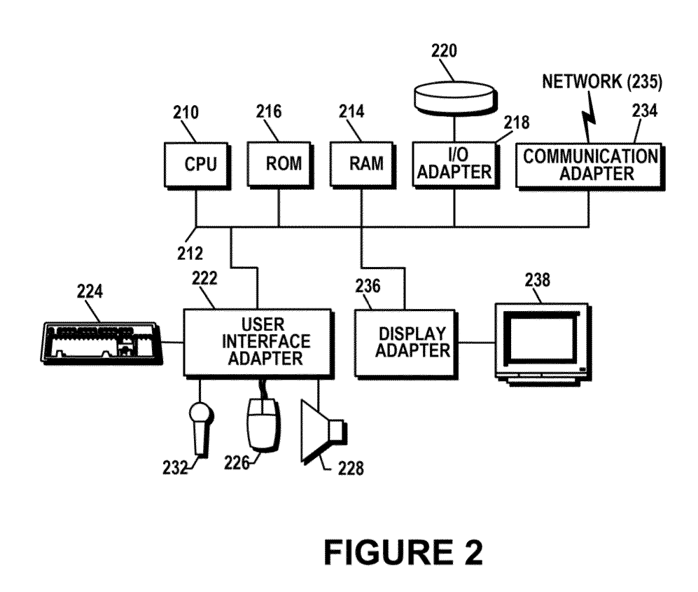

FIG. 2 shows a representative hardware environment that may be associated with the servers 104 and/or clients 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

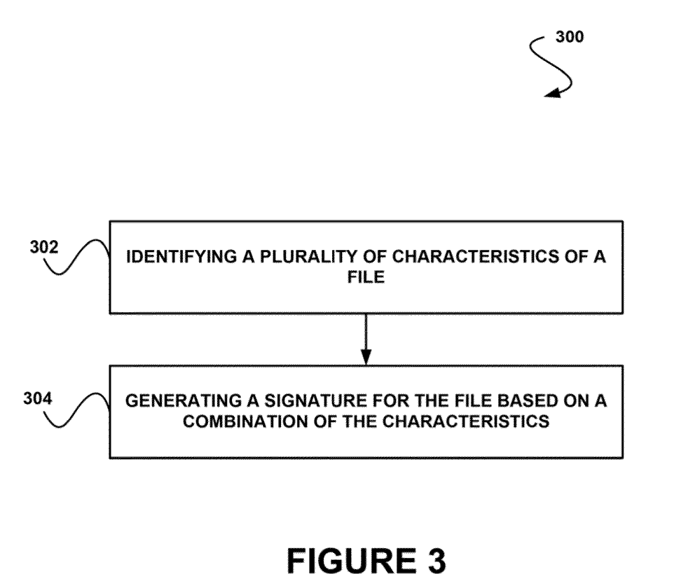

FIG. 3 shows a method 300 for generating a file signature using file characteristics, in accordance with one embodiment. As an option, the method 300 may be carried out in the context of the architecture and environment of FIGS. 1 and/or 2. Of course, however, the method 300 may be carried out in any desired environment.

As shown in operation 302, a plurality of characteristics of a file is identified. With respect to the present description, the file may include any type of file for which characteristics may be identified. Just by way of example, the file may include an executable file (e.g. subdivided into a plurality of sections, etc.). In other optional embodiments, the file may include a compressed (e.g. packed) file, an uncompressed file, an encrypted file, an unencrypted file, etc.

Further, the characteristics of the file may include any features, descriptors, etc. of the file which are capable of being identified. In various embodiments, the characteristics may include a machine type on which the file is capable of being executed (e.g. a target CPU architecture), a version of the file, a hash of all characteristics of the file (e.g. characteristics of all section of the file) that are of a predetermined characteristic type, a hash of characteristics of a largest section of the file that are of a predetermined characteristic type, a hash of characteristics of a smallest section of the file that are of a predetermined characteristic type, a hash of a largest section of the file, a hash of a smallest section of the file, identifiers of resources of the file, data appended to the file, imports of the file (e.g. import table), etc.

Optionally, the characteristics of the file may include at least one measurement associated with the file. For example, the measurement may include a compressed size of the file, an uncompressed size of the file, a ratio of the compressed size of the file to the uncompressed size of the file, an information density associated with the file where the information density indicates an amount of information stored in bits per byte (e.g. information density of the file in an uncompressed state, information density of a first predetermined number of bytes of a largest uncompressed section of the file, etc.), an amount of (e.g. a size of) initialized data stored in the file, an amount of uninitialized data stored in the file, a size of headers of the file, a number of sections in the file, a size of resources of the file, a size of imports of the file, etc.

Further, the characteristics may include a bit mask. For example, the bit mask may indicate whether the file contains base relocations and must therefore be loaded at its preferred base address, whether line numbers have been removed and symbol table entries for local symbols have been removed, whether debugging information has been removed from image file or whether it handles over 2GB addresses, that the most significant bit precedes the least significant bit in memory, whether the image file is a system file or a user program, whether The image file is a dynamic-link library (DLL), etc.

It should be noted that the characteristics may be identified in any desired manner. In one embodiment, the characteristics may be identified based on predetermined types of characteristics. For example, for each predetermined type of characteristic (e.g. machine type, etc.), a corresponding characteristic of the file may be identified (e.g. an identifier of the particular machine on which the file may be executed, etc.).

In another embodiment, at least a portion of the characteristics of the file may be identified utilizing a section directory of the file. For example, the section directory of the file may publish each section of the file in addition to a corresponding size of each section of the file. Such section sizes may thus be used in determining characteristics that involve (e.g. include, are measured using, etc.) a section size of the file, such as the ratio of the compressed size of the file to the uncompressed size of the file. As another example, the number of sections published by the section directory may be counted for determining the number of sections in the file.

In another embodiment, at least a portion of the characteristics of the file may be identified by calculating the characteristics that are a measurement associated with the file. Just by way of example, a characteristic including a ratio of the compressed size of the file to the uncompressed size of the file may be identified by calculating the ratio between the compressed size of the file and the uncompressed size of the file. As another example, a characteristic including a number of sections in the file may be identified by counting a number of sections in the file (e.g. a number of sections indicated by the section directory of the file). As yet another example, a characteristic including a size of the file in a compressed state may be identified by identifying a size of memory that holds the compressed file, and a characteristic including a size of the file in an uncompressed state may be identified by identifying a size of memory that is to store the uncompressed file.

As a further example, at least a portion of the characteristics of the file may be identified utilizing a checksum of a portion of the file. As yet another example, at least a portion of the characteristics of the file are identified utilizing an entropy of a portion of the file (e.g. an information density associated with the file).

As also shown, a signature is generated for the file based on a combination of the characteristics. Note operation 304. With respect to the present description, the signature may include any identifier of the file that is generated based on a combination of the identified characteristics of the file. To this end, the signature may include a fingerprint, hash, etc. of the combination of the characteristics of the file.

In one embodiment, the signature may include a sequence of the characteristics. The sequence may be based on a predetermined sequence of predefined characteristics types, where the characteristics were identified based on the predefined characteristics types, as an option. Just by way of example, if the predetermined sequence of predefined characteristics types indicates that a version of the file is to be first in the sequence, a machine type associated with the file is to be second in the sequence, a ratio of the compressed size of the file to the uncompressed size of the file is to be third in the sequence, and so forth., then the version of the file may be stored first in the sequence, the machine type associated with the file may be stored second in the sequence, the ratio of the compressed size of the file to the uncompressed size of the file may be stored third in the sequence, etc.

In another embodiment, the signature may include a predetermined number of bytes for storing each characteristic. Just by way of example, a characteristic identifying a machine type on which the file is capable of being executed may be stored in four bits of the signature. As another example, a hash of characteristics of a largest section of the file may be stored in one byte of the signature. As another option, at least some of the characteristics may be stored in the signature as a bit mask, as noted above. In this way, the size of the signature may be predetermined, such that the generated signature may not exceed the predetermined size.

In another embodiment, the signature may be generated by storing the combination of the characteristics in a data structure (e.g. a file, a record of a database, etc.). For example, the characteristics may be stored in sequence in the data structure. Of course, however, the signature may be generated in any manner that is based on the combination of the characteristics.

In this way, a signature of the file may be generated automatically (e.g. without necessarily requiring manual intervention) based on a combination of identified characteristics of the file. The signature may optionally be utilized for various different purposes. In one exemplary embodiment, the signature may be used during anti-virus (or other anti-malware) scanning (e.g. behavioral scanning, etc.). For example, the file may be predetermined to include unwanted data (e.g. a virus, etc.), such that the signature of the file may be applied to signatures of other files for determining whether such other files also include unwanted data. In another exemplary embodiment, the signature may be formed of a normalized hash that is suitable for automated generation and comparison to detect unwanted files whilst tolerating degrees of variation within these unwanted files.

Thus, the signature may be compared to a signature of another file, where the signature of the other file is also generated using a combination of characteristics of such other file, for determining whether such other file includes the unwanted data. As an option, the other file may be classified as unwanted in response to a determination (based on the comparison) that the signature exactly matches the signature of the other file.

As another option, the other file may be classified as unwanted in response to a determination (based on the comparison) that the signature matches the signature of the other file by a predetermined deviation associated with the signature of the file predetermined to include the unwanted data. The predetermined deviation may be for the entire signature (e.g. may indicate a threshold for a total aggregate difference among all of the characteristics of the two files, may indicate a threshold for a total number of characteristics that are difference, etc.), in one embodiment. Thus, with respect to such embodiment, an aggregate difference between the signature of the file predetermined to include the unwanted data and the signature of the other file may be determined (e.g. by aggregating the differences of each characteristic in the signatures, by counting a number of characteristics that are different between the signatures, etc.) and compared to the threshold for determining whether the signatures match by the predetermined deviation.

In another embodiment, the predetermined deviation maybe specified for each characteristic in the signature (e.g. may be different for each characteristic of the file predetermined to include the unwanted data). Accordingly, with respect to such embodiment, a difference between each characteristic in the signatures may be calculated and compared to the predetermined deviation specified for such characteristic. If any (or a predetermined number) of the characteristics, or optionally a characteristic of a predetermined characteristic type, deviate beyond the predetermined deviation, it may be determined that the signatures do not match, for example. Otherwise, it may be determined that the signatures do match.

It should be noted that the signature may include the predetermined deviation for each of the characteristics and/or the predetermined deviation for the entire signature, as an option. Of course, as another option, the predetermined deviation signatures match by the predetermined deviation may be stored outside of the signature, and referenced during application of the signature to the signature of the other file. In another exemplary embodiment, the signature may be used for preventing false detections of unwanted data (e.g. by using the deviation described above, such that files outside of the predetermined deviation may be prevented from being identified as matching the signature).

For example, malware authors may routinely pack or obfuscate their code in an effort to hide its contents and functionality from anti-virus scanners. The malware authors may use custom encryption algorithms as well as publically available packers [e.g. the ultimate packer for executables (UPX)] in order to achieve this end. Thus, by using a signature with a predetermined deviation, a single signature may be used to detect multiple different files of unwanted data that have been obfuscated within the predetermined deviation. Further, by using a signature with a predetermined deviation, the signature may be used to detect other files with unwanted data within the predetermined deviation, even though such unwanted data may have previously been encountered (e.g. known, detected, etc.).

In yet another exemplary embodiment, the signature may be used to classify the file. For example, the signature may be compared to signatures associated with various classifications, and may be classified according to the classification with the matching signature. Of course, the predetermined deviation described above may also be applied when determining if the signature of the file matches (by the predetermined deviation) the signature of the classification.

By classifying files using the signature of the combination of the file characteristics, files (e.g. with confidential data, etc.) may be classified without disclosing the contents of the files. In addition, by classifying files using the signature of the combination of the file characteristics, the classification of the file (e.g. wanted, unwanted, etc.) may be determined prior to allowing the entire file to be transmitted (e.g. over a network), opened, uncompressed, etc. For example, the signature of the file may be transmitted, opened, uncompressed, etc. prior to the contents of the file, such that the classification of the file may be determined prior to the contents of the file being transmitted, opened, uncompressed, etc. In this way, the contents of the file may be prevented from being transmitted (e.g. utilizing a firewall, etc.), opened, uncompressed, etc. based on the classification, as an option.

In yet a further exemplary embodiment, clustering algorithms may optionally use the signature to cluster the file with other similar files (e.g. whose differences are less than the predetermined deviation). Using the signature for such clustering may allow similar files to be identified without necessarily having to classify each of the files separately.

In still yet another exemplary embodiment, the signature may be compared to other signatures by using a wildcard to substitute one or more characteristics of the signature. The wildcard may be utilized in this manner for throttling a slower method of malware detection in order to gain performance, as an option. As another option, the wildcard may be utilized in the above manner for heuristically detecting malware via the presence of certain characteristics in the signature (e.g. within the predetermined deviation described above) that are determined to be more commonly associated with suspicious files than clean files. In another exemplary embodiment, the signature may be used in combination with other detection techniques for the purpose of malware detection.

More illustrative information will now be set forth regarding various optional architectures and features with which the foregoing technique may or may not be implemented, per the desires of the user. It should be strongly noted that the following information is set forth for illustrative purposes and should not be construed as limiting in any manner. Any of the following features may be optionally incorporated with or without the exclusion of other features described.

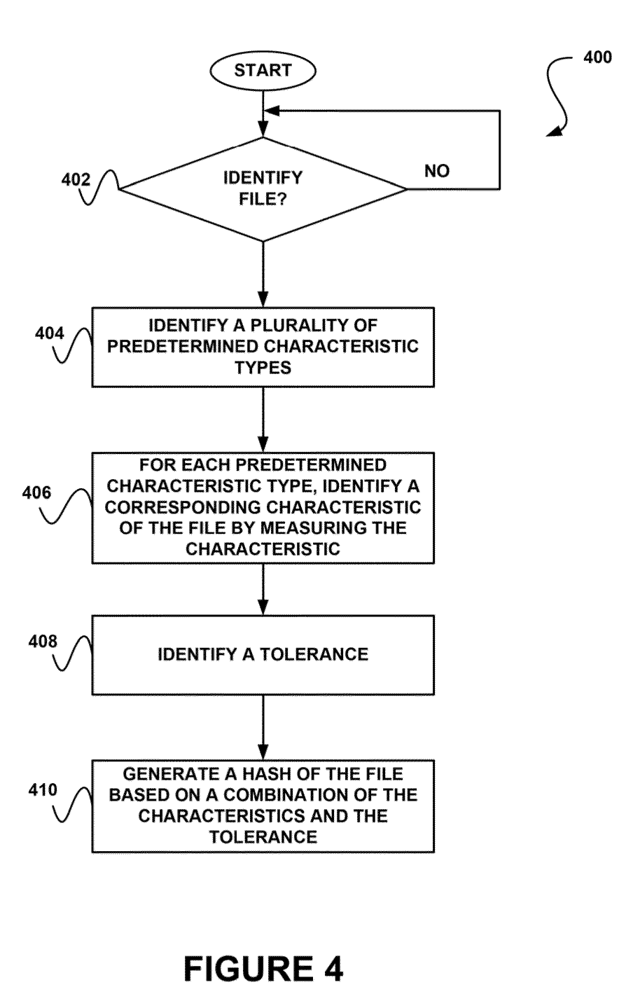

FIG. 4 shows a method 400 for generating a hash of a file based on a combination of characteristics of the file, in accordance with another embodiment. As an option, the method 400 may be carried out in the context of the architecture and environment of FIGS. 1-3. Of course, however, the method 400 may be carried out in any desired environment. It should also be noted that the aforementioned definitions may apply during the present description.

As shown in decision 402, it is determine whether a file is identified. In one embodiment, the file may be identified in response to a determination that the file may potentially include unwanted data (e.g. the file is associated with suspicious activity, etc.). In another embodiment, the file may be identified in response to a request to transmit the file (e.g. over a network, etc.). In yet another embodiment, the file may be identified in response to a request to scan the file (e.g. an on-demand scan, an on-access scan, etc.) for unwanted data. In still yet another embodiment, the file may be identified for classifying the file.

If it is determined that a file is not identified, the method 400 continues to wait for a file to be identified. If, however, it is determined that a file is identified, a plurality of predetermined characteristic types are identified. Note operation 404. The predetermined characteristic types may include any types of characteristics capable of being associated with the file that are predetermined (e.g. by an administrator, etc.).

Just by way of example, the predetermined characteristic types may include a machine type, a version a hash of a largest section, a hash of a smallest section, identifiers of resources, appended data, imports, a compressed size, an uncompressed size, a ratio of the compressed size to the uncompressed size, an information density, an amount of initialized data, an amount of uninitialized data, a size of headers, a number of sections, a size of resources, a size of imports, etc.

Further, for each predetermined characteristic type, a corresponding characteristic of the file is identified by measuring the characteristic, as shown in operation 406. Accordingly, the characteristics may include a hash of a largest section of the file, a hash of a smallest section of the file, a compressed size of the file, an uncompressed size of the file, a ratio of the compressed size of the file to the uncompressed size of the file, an information density associated with the file, an amount of initialized data stored in the file, an amount of uninitialized data stored in the file, a size of headers of the file, a number of sections in the file, a size of resources of the file, a size of imports of the file, etc.

Still yet, as shown in operation 408, a tolerance is identified. The tolerance may include any degree of variation. For example, the tolerance may indicate a degree of variation between different signatures (each signature generated based on characteristic combinations) within which the signatures may be considered to match. Thus, if the signatures are within the tolerance, the signatures may be determined to match.

In one embodiment, a separate tolerance may be identified for each predetermined characteristic type. In this way, a plurality of tolerances may be identified. In another embodiment, the tolerance may be identified for the combination of the characteristics. It should be noted that the tolerance may be identified in any desired manner. For example, the tolerance for the combination of the characteristics may be predetermined, the tolerance may be predetermined for each predetermined characteristic type, etc.

Moreover, as shown in operation 410, a hash of the file is generated based on a combination of the characteristics and the tolerance. In one embodiment, the hash of the file may be generated by storing the characteristics in a predetermined sequence in a data structure representative of the hash. Such predetermined sequence may list the predetermined characteristic types based on which characteristics of the file are identified. Thus, the predetermined sequence may also optionally be used to identify the plurality of predetermined characteristic types in operation 404. In another embodiment, the hash of the file may be generated by storing the tolerance in the data structure representative of the hash.

Table 1 illustrates one example of a combination of characteristics of a file which may be used to generate a hash for the file. The characteristics may optionally be associated with a Microsoft® portable executable (PE) file. It should be noted that the hash is set forth for illustrative purposes only, and thus should not be construed as limiting in any manner.

TABLE 1

| Field Size | Value | |
|---|---|---|
| (BITs) | (Hexadecimal) | Description |
| 16 | 4c 01 | PE Machine ID that the executable |
| | | can run upon |
| 16 | 05 00 | Number of sections |
| 16 | 3d 00 | Ratio of the size of the largest section |
| | | of the file on disk to the size required |
| | | in memory to store the section with |
| | | the smallest size on disk. |
| 16 | F0 01 | Size of largest section on disk divided |
| | | by 256 modulus 65536 |
| 16 | 08 00 | Size of the smallest section on disk |
| | | divided by 256 modulus 65536 |
| 8 | 15 | Measure of the entropy of the first |
| | | kilobyte of the data within the largest |
| | | section on disk. |
| 16 | 20 00 | The PE characteristics of the largest |
| | | section |
| 16 | 40 00 | The PE characteristics of the smallest |
| | | section |

As shown, the hash of Table 1 includes a plurality of different characteristics, each described under the description column. For example, the characteristics include a PE Machine identifier upon which the file can execute, a number of sections of the file, a ratio of the size of the file in an uncompressed state and a size of the file in a compressed state, etc.

For each characteristic, a size of the value for characteristic that may be stored in the hash is defined. Such value sizes may be designated by the hash (see Field Size). As shown, the size may be designated in bits, but in other embodiments may also be designated in bytes, etc. Moreover, a value of each characteristic (e.g. that is indicative of each characteristic) is stored in the hash.

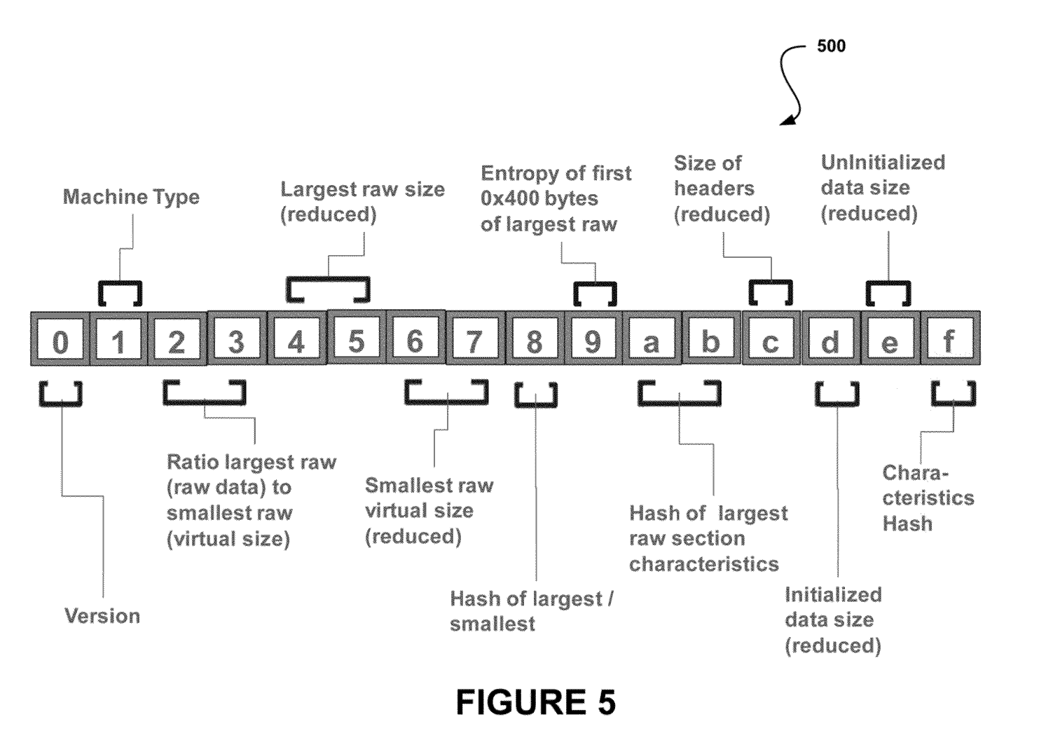

FIG. 5 shows a file signature 500 which describes a plurality of file characteristics, in accordance with yet another embodiment. As an option, the file signature 500 may be implemented in the context of the architecture and environment of FIGS. 1-3. Of course, however, the file signature 500 may be implemented in any desired environment. Again, it should be noted that the aforementioned definitions may apply during the present description.

As shown, the file signature 500 includes a combination of a plurality of characteristics of a file. Each block shown in the file signature 500 may be four bits of the file signature 500. Thus, as shown, some file characteristics may be represented by four bits (one block), whereas other file characteristics may be represented by eight bits (two blocks). In this way, the size of a value of a characteristic that is stored in the file signature 500 may not exceed the number of bits designated for that characteristic by the file signature 500.

It should be noted that he characteristics included in the file signature may include any features, descriptors, etc. of the file. However, with respect to the present embodiment, the characteristics may include a version of the file, a machine type on which the file may be executed (e.g. on which the file is attempted to be executed, etc.), a size of the file in an uncompressed state (shown as largest raw size), a size of the file in a compressed size (shown as smallest raw virtual size), a ratio of the size of the file in an uncompressed state and a compressed state, an information density of a first number of bytes of a largest section of the file (shown as entropy), a hash of characteristics of a largest section of the file, a size of headers of the file, a size of initialized data in the file, a size of uninitialized data in the file, and a hash of all characteristics of the file that are of predetermined characteristic types.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A computer program product embodied on a non-transitory computer readable medium for performing operations, comprising:
identifying a plurality of characteristics of a first file, wherein at least one of the plurality of characteristics is associated with a bit mask to indicate whether the first file contains base relocations such that it should be loaded at a preferred base address;
generating a first signature for the first file based on a combination of the characteristics; and
scanning a computer for unwanted data by comparing the first signature to a second signature of another file to determine whether the other file includes unwanted data, wherein a match is determined to exist between the first signature and the second signature based on a predetermined deviation associated with the first signature, and wherein the predetermined deviation includes an associated threshold for a total aggregate difference among all characteristics between the first file and the other file, and wherein degrees of variation of the unwanted data that exceed the threshold are tolerated in the computer.

2. The computer program product of claim 1, wherein the first file includes an executable file.

3. The computer program product of claim 1, wherein the characteristics of the first file include a machine type on which the first file is located.

4. The computer program product of claim 1, wherein the characteristics of the first file include a version of the first file.

5. The computer program product of claim 1, wherein the characteristics of the first file include a hash of all characteristics of the first file that are of a predetermined characteristic type.

6. The computer program product of claim 1, wherein the characteristics of the first file include a hash of characteristics of a largest section of the first file that are of a predetermined characteristic type.

7. The computer program product of claim 1, wherein the characteristics of the first file include a hash of a largest section of the first file and a hash of the smallest section of the first file.

8. The computer program product of claim 1, wherein the characteristics of the first file include at least one measurement associated with the first file.

9. The computer program product of claim 8, wherein the at least one measurement includes a ratio of a compressed size of the first file to an uncompressed size of the first file.

10. The computer program product of claim 8, wherein the at least one measurement includes a compressed size of the first file and an uncompressed size of the first file.

11. The computer program product of claim 1, wherein at least a portion of the characteristics of the first file are identified utilizing a section directory of the first file.

12. The computer program product of claim 1, wherein the first signature includes a sequence of the characteristics.

13. The computer program product of claim 1, wherein the first signature includes a predefined deviation for each of the characteristics.

14. The computer program product of claim 1, wherein the first signature includes a predefined deviation for the first signature.

15. The computer program product of claim 1, wherein the first file is predetermined to include the unwanted data.

16. The computer program product of claim 15, further comprising:
classifying the other file as unwanted in response to a determination that the first signature matches the second signature of the other file.

17. The computer program product of claim 15, further comprising:
classifying the other file as unwanted in response to a determination that the first signature matches the second signature of the other file by a particular predetermined deviation associated with an aggregate difference among all characteristics of the first file and the other file.

18. The computer program product of claim 1, wherein the computer program product is operable such that the first signature is utilized for classifying the first file.

19. The computer program product of claim 1, wherein the computer program product is operable such that at least a portion of the characteristics of the first file are identified utilizing a checksum of a portion of the first file

20. The computer program product of claim 1, wherein the computer program product is operable such that at least a portion of the characteristics of the first file are identified utilizing an entropy of a portion of the first file.

21. A method, comprising:
identifying a plurality of characteristics of a first file, wherein at least one of the plurality of characteristics is associated with a bit mask to indicate whether the first file contains base relocations such that it should be loaded at a preferred base address;
generating a first signature for the first file based on a combination of the characteristics; and
scanning a computer for unwanted data by comparing the first signature to a second signature of another file to determine whether the other file includes unwanted data, wherein a match is determined to exist between the first signature and the second signature based on a predetermined deviation associated with the first signature, and wherein the predetermined deviation includes an associated threshold for a total aggregate difference among all characteristics between the first file and the other file, and wherein degrees of variation of the unwanted data that exceed the threshold are tolerated in the computer.

22. A system, comprising:
a processor, wherein the system is configured for:
identifying a plurality of characteristics of a first file, wherein at least one of the plurality of characteristics is associated with a bit mask to indicate whether the first file contains base relocations such that it should be loaded at a preferred base address;
generating a first signature for the first file based on a combination of the characteristics; and
scanning a computer for unwanted data by comparing the first signature to a second signature of another file to determine whether the other file includes unwanted data, wherein a match is determined to exist between the first signature and the second signature based on a predetermined deviation associated with the first signature, and wherein the predetermined deviation includes an associated threshold for a total aggregate difference among all characteristics between the first file and the other file, and wherein degrees of variation of the unwanted data that exceed the threshold are tolerated in the computer.

23. The system of claim 22, wherein the processor is coupled to memory via a bus.
